(19) United States
(12) Patent Application Publication
(10) Pub. No.: US 2023/0408405 A1
(43) Pub. Date: Dec. 21, 2023

(54) RAPID MOISTURE DETECTION DEVICE FOR TEA LEAF PROCESSING PROCESS

(71) Applicant: Zhejiang University, Hangzhou City (CN)

(72) Inventors: Liwen HE, Hangzhou City (CN); Yong HE, Hangzhou City (CN); Xiaoli LI, Hangzhou City (CN)

(21) Appl. No.: 18/149,853

(22) Filed: Jan. 4, 2023

(30) Foreign Application Priority Data
Jun. 17, 2022 (CN) 202210690439.6

(51) Int. Cl. G01N 21/3554; G01N 21/359

(52) U.S. Cl. CPC G01N 21/3554; G01N 21/359

(57) ABSTRACT

The present disclosure relates to a rapid moisture detection device for a tea leaf processing process, and belongs to the field of moisture detection. According to the present disclosure, when a sliding unit drives a laser wave emission unit to move, the laser wave emission unit can also receive an echo reflected by tea leaves on a production line while emitting a laser wave, and then an upper computer determines the moisture content of the tea leaves on the production line based on the emitted laser wave and the received echo, so as to realize rapid, non-destructive, and high-throughput detection of the moisture content of the tea leaves.

### CROSS-REFERENCE TO RELATED APPLICATION

This application claims priority to Chinese Patent Application No. 202210690439.6, filed on Jun. 17, 2022, which is hereby incorporated by reference in its entirety.

### TECHNICAL FIELD

The present disclosure relates to the technical field of moisture detection, and in particular, to a rapid moisture detection device for a tea leaf processing process.

### BACKGROUND

Tea products are made from fresh tender shoots of tea leaves through a series of physical and chemical changes. Processing processes of green tea includes the processes of performing fixation, rolling, drying, etc. In these processing processes, moisture content directly affects the physical state and the chemical reaction progress of raw materials, which is a key factor t for the quality of tea leaves. Taking the process of performing fixation as an example, the key technology of fixation is to determine the fixation time and the fixation temperature for the moisture content of leaves. However, at present, the moisture content of the tea leaves is accurately measured by a drying weighing method, which takes a long time to measure and requires at least 1 to 2 hours. In addition, a high-temperature drying process destroys the nutritional ingredients of the tea leaves, which results that test samples cannot be eaten any more, and cannot meet the requirement of real-time detection in a tea leaf processing process.

### SUMMARY

In order to solve the abovementioned problems in the prior art, the present disclosure provides a rapid moisture detection device for a tea leaf processing process.

In order to achieve the abovementioned objective, the present disclosure provides the following solutions.

A rapid moisture detection device for a tea leaf processing process includes: a laser wave emission unit, a sliding unit, and an upper computer.

The sliding unit is arranged on a side of a conveyor belt of a tea leaf processing production line. The laser wave emission unit is arranged on the sliding unit. The laser wave emission unit is electrically connected to the upper computer.

The sliding unit is configured for driving the laser wave emission unit to move. The laser wave emission unit is configured for emitting a laser wave, and is configured for receiving an echo reflected by tea leaves on the production line. The upper computer is configured for determining the moisture content of the tea leaves on the processing production line based on the laser wave and the echo.

In some embodiments, the laser wave emission unit includes: an area array solid state laser radar and a bracket.

The bracket is arranged on the sliding unit. The area array solid state laser radar is mounted on the bracket. The area array solid state laser radar is electrically connected to the upper computer.

In some embodiments, the sliding unit includes: sliding rails, a control motor, and a driving screw rod.

The control electric motor is connected to the driving screw rod. The bracket is mounted on the driving screw rod. The control electric motor is configured for driving the driving screw rod. The driving screw rod is configured for driving the bracket to slide on the sliding rails.

In some embodiments, the sliding unit further includes: a screw rod fixing seat. The screw rod fixing screw is used for limiting a displacement distance of the driving screw rod.

In some embodiments, a wavelength of laser emitted by the area array solid state laser radar is a near-infrared wavelength.

In some embodiments, the upper computer acquires echo data of the tea leaves on the production line. The echo data includes first echo data and second echo data. The first echo data is echo data acquired after the area array solid state laser radar and the conveyor belt move synchronously for a period of time. The second echo data is echo data acquired after the area array solid state laser radar moves relative to the conveyor belt for a period of time.

The upper computer removes clutter from the echo data based on Doppler effect, and determines the moisture content of the tea leaves based on the echo data after removal of the clutter and the laser data emitted by the area array solid state laser radar.

According to specific embodiments provided by the present disclosure, the present disclosure discloses the following technical effects:

According to the rapid moisture detection device for the tea leaf processing process provided by the present disclosure, when the sliding unit drives the laser wave emission unit to move, the laser wave emission unit can also receive an echo reflected by tea leaves on a production line while emitting a laser wave, and then the upper computer determines the moisture content of the tea leaves on the production line based on the emitted laser wave and the received echo, so as to realize rapid, non-destructive, and high-throughput detection of the moisture content of the tea leaves.

### BRIEF DESCRIPTION OF THE DRAWINGS

To describe the technical solutions in the embodiments of the present disclosure or in the prior art more clearly, the following briefly describes the drawings required for describing the embodiments. Apparently, the drawings in the following description are merely some embodiments of the present disclosure, and those of ordinary skill in the art may still derive other drawings from these drawings without creative efforts.

FIG. 1 is a schematic structural diagram of a rapid moisture detection device for a tea leaf processing process provided by the present disclosure;

FIG. 2 is a schematic diagram of waveforms of echoes received when a radar and a conveyor belt move synchronously, provided by the present disclosure; and

FIG. 3 is a schematic diagram of waveforms of echoes received when the radar moves relative to the conveyor belt, provided by the present disclosure.

### REFERENCE NUMERALS

1—area array solid state laser radar; 2—bracket; 3—conveyor belt; 4—control electric motor; 5—sliding rail; 6—driving screw rod; and 7—screw rod fixing seat.

### DETAILED DESCRIPTION OF THE EMBODIMENTS

Technical solutions in the embodiments of the present disclosure will be clearly and completely described below with reference to the drawings in the embodiments of the present disclosure. Apparently, the described embodiments are merely part rather than all of the embodiments of the present disclosure. On the basis of the embodiments of the present disclosure, all other embodiments obtained by those of ordinary skill in the art without creative efforts fall within the scope of protection of the present disclosure.

An objective of the present disclosure is to provide a rapid moisture detection device for a tea leaf processing process, which can realize rapid, non-destructive, and high-throughput detection of moisture content of tea leaves in a current processing process.

In order to make the abovementioned objective, features, and advantages of the present disclosure more apparent and more comprehensible, the present disclosure is further described in detail below with reference to the drawings and specific implementation modes.

A rapid moisture detection device for a tea leaf processing process provided by the present disclosure includes: a laser wave emission unit, a sliding unit, and an upper computer.

The sliding unit is arranged on one side of a conveyor belt 3 of a tea leaf processing production line. The laser wave emission unit is arranged on the sliding unit. The laser wave emission unit is electrically connected to the upper computer.

The sliding unit is used for driving the laser wave emission unit to move. The laser wave emission unit is used for emitting a laser wave, and is used for receiving an echo reflected by tea leaves on the production line. The upper computer is used for determining the moisture content of the tea leaves on the processing production line based on the laser wave and the echo.

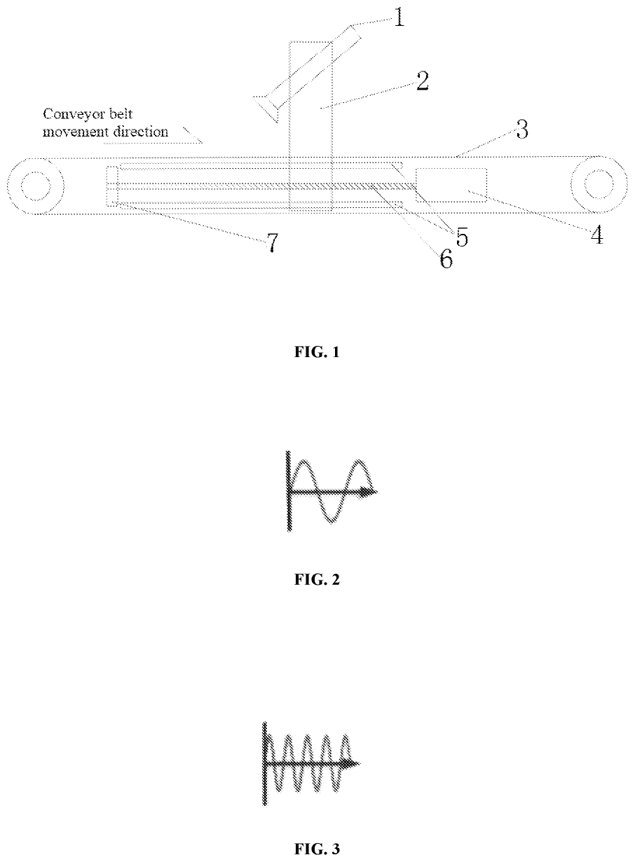

In order to further improve the accuracy of determining the moisture content of the tea leaves, in the present disclosure, the adopted laser wave emission unit mentioned above may specifically include an area array solid state laser radar 1 and a bracket 2, as shown in FIG. 1.

The bracket 2 is arranged on the sliding unit. The area array solid state laser radar 1 is mounted on the bracket 2. The area array solid state laser radar 1 is electrically connected to the upper computer. A wavelength of the laser emitted by the area array solid state laser radar 1 is a near-infrared wavelength.

As shown in FIG. 1, the sliding unit includes: sliding rails 5, a control electric motor 4, and a driving screw rod 6.

The control electric motor 4 is connected to the driving screw rod 6. The bracket 2 is mounted on the driving screw rod 6. The control motor 4 is used for driving the driving screw rod 6. The driving screw rod 6 is used for driving the bracket 2 to slide on the sliding rails 5.

In order to further optimize the solution, a screw rod fixing seat 7 is also arranged in the sliding unit. The screw rod fixing screw 7 is used for limiting a displacement distance of the driving screw rod 6.

During determining the moisture content, the upper computer acquires echo data of the tea leaves on the production line. The echo data includes first echo data and second echo data. The first echo data is the echo data acquired after the area array solid state laser radar 1 and the conveyor belt 3 move synchronously for a period of time. The second echo data is the echo data acquired after the area array solid state laser radar 1 moves relative to the conveyor belt 3 for a period of time.

The upper computer removes clutter from the echo data based on the Doppler effect, and determines the moisture content of the tea leaves based on the echo data after the removal of the clutter and the laser data emitted by the area array solid state laser radar 1.

A specific working process of the rapid moisture detection device for the tea leaf processing process provided above is described below based on the position relationship between the sliding unit and the conveyor belt as shown in FIG. 1. In a practical application process, the mounting mode as shown in FIG. 1 is not the only limitation to a structure of the abovementioned rapid moisture detection device in the tea leaf processing process provided by the present disclosure.

According to the present disclosure, the area array solid state laser radar 1 is mounted in a space above the conveyor belt 3 of the tea leaf production line at a variable angle within a certain scope, and the sliding rails 5 are mounted on a side surface of the conveyor belt 3, so that the sliding rails 5 and the conveyor belt 3 move for a distance in the same direction. During detecting, a laser wave is emitted to the tea leaves on the conveyor belt 3, and an echo reflected by the tea leaves is received. Since the used laser is the light with a near-infrared wavelength, the relative moisture content can be obtained through the intensity of the received echo by using the characteristic that the light with the near-infrared wavelength is easily absorbed by moisture. Low echo signal intensity indicates high moisture content, while high received echo intensity indicates low moisture content.

However, due to the characteristic of the continuity of the production line for processing the tea leaves, the conveyor belt 3 cannot be stopped due to detection, and meanwhile, continuous and accurate detection is also required. Therefore, the area array solid state laser radar 1 and the conveyor belt 3 are moved synchronously for a distance by using the sliding rails 5 on the side surface of the conveyor belt 3. At this time, the relative speed between the area array solid state laser radar 1 and the detected tea leaves is zero. In the absence of relative moment, the obtained radar echo intensity data of the detected tea leaves is as shown in FIG. 2.

In addition, due to a plurality of factors of the material of the conveyor belt 3, the irregularity of the tea leaves, etc., much clutter may be generated. By using the law that the clutter appears randomly and unstably, the area array solid state laser radar 1 stops moving after moving with the conveyor belt 3 at a constant speed for a certain distance, and the detected tea leaves on the conveyor belt 3 may move relative to the area array solid state laser radar 1. At this time, the characteristic of the Doppler effect of echo data is used, irregular reflected echoes generated by the clutter that does not conform to this characteristic can be well removed, as shown in FIG. 3. In the present embodiment, the Doppler effect refers to that there is relative movement between the area array solid state laser radar and the tea leaves. The signal waveform may be compressed or widened. The reflected echoes of the area array solid state laser radar may produce frequency offset, and the offset has the characteristic of being in direct proportion to the relative radial velocity between a scatterer and the area array solid state laser radar.

After the clutter is removed, rapid, non-destructive, and high-throughput detection of the moisture content in a tea leaf production process is realized by using the high-frequency operation of the area array solid state laser radar.

Various embodiments in the present specification are described in a progressive manner. Each embodiment focuses on differences from other embodiments, and the same and similar parts of various embodiments may be referred to one another.

In this specification, specific examples are used to describe the principle and implementation manners of the present disclosure. The description of the embodiments above is merely intended to help understand the method and core idea of the present disclosure. In addition, those skilled in the art may make modifications based on the idea of the present disclosure with respect to the specific implementation manners and the application scope. In conclusion, the contents of the present specification shall not be construed as a limitation to the present disclosure.

What is claimed is:

1. A rapid moisture detection device for a tea leaf processing process, comprising: a laser wave emission unit, a sliding unit, and an upper computer, wherein
the sliding unit is arranged on a side of a conveyor belt of a tea leaf processing production line; the laser wave emission unit is arranged on the sliding unit; the laser wave emission unit is electrically connected to the upper computer;
the sliding unit is configured for driving the laser wave emission unit to move; the laser wave emission unit is configured for emitting a laser wave, and is configured for receiving an echo reflected by tea leaves on the production line; and the upper computer is configured for determining moisture content of the tea leaves on the processing production line based on the laser wave and the echo.

2. The rapid moisture detection device according to claim 1, wherein the laser wave emission unit comprises: an area array solid state laser radar and a bracket;
the bracket is arranged on the sliding unit; the area array solid state laser radar is mounted on the bracket; and the area array solid state laser radar is electrically connected to the upper computer.

3. The rapid moisture detection device according to claim 2, wherein the sliding unit comprises: sliding rails, a control electric motor, and a driving screw rod;
the control electric motor is connected to the driving screw rod; the bracket is mounted on the driving screw rod; the control electric motor is configured for driving the driving screw rod;
and the driving screw rod is configured for driving the bracket to slide on the sliding rails.

4. The rapid moisture detection device according to claim 3, wherein the sliding unit further comprises: a screw rod fixing seat which is configured for limiting a displacement distance of the driving screw rod.

5. The rapid moisture detection device according to claim 2, wherein a wavelength of laser emitted by the area array solid state laser radar is a near-infrared wavelength.

6. The rapid moisture detection device according to claim 3, wherein the upper computer acquires echo data of the tea leaves on the production line; the echo data comprises first echo data and second echo data; the first echo data is echo data acquired after the area array solid state laser radar and the conveyor belt move synchronously for a period of time; the second echo data is echo data acquired after the area array solid state laser radar moves relative to the conveyor belt for a period of time; and
the upper computer removes clutter from the echo data based on Doppler effect, and determines the moisture content of the tea leaves based on the echo data after removal of the clutter and laser data emitted by the area array solid state laser radar.
